(19) United States
(12) Patent Application Publication
(10) Pub. No.: US 2008/0148553 A1
(43) Pub. Date: Jun. 26, 2008

(54) Extracting particles from a slider to enable particle quantification

(76) Inventors: Yiqi Feng, Singapore (SG); Hui Yan Hu, Singapore (SG); Sai H. Wong, Singapore (SG); Yi Zhao Yao, Singapore (SG)

Correspondence Address: HITACHI C/O WAGNER BLECHER LLP, 123 WESTRIDGE DRIVE, WATSONVILLE, CA, 95076, US

(21) Appl. No.: 11/643,153

(22) Filed: Dec. 20, 2006

(51) Int. Cl. G11B 5/127

(52) U.S. Cl. 29/603.12; 29/603.05; 29/603.03; 360/245.8

(57) ABSTRACT

Embodiments of the present invention pertain to extracting particles from a slider to enable particle quantification. According to one embodiment, a slider, which is associated with a head stack assembly, is submerged into a solution. Particles are extracted from the slider without extracting particles from the entire head stack assembly.

### TECHNICAL FIELD

Embodiments of the present invention relate to manufacturing sliders for hard disk drives. More specifically, embodiments of the present invention relate to extracting particles from a slider to enable particle quantification.

### BACKGROUND

Manufacturing disk drives is a very competitive business. People that buy disk drives are demanding more and more for their money. For example, they want disk drives that are more reliable and have more capabilities. One way to provide more capabilities is to make the various disk drive parts smaller.

Typically a hard disk drive (HDD) uses an actuator assembly for positioning read/write heads at the desired location of a disk to read data from and/or write data to the disk. The read/write heads can be mounted on what is known as a slider. Generally, a slider provides mechanical support for a read/write head and electrical connections between the head and the drive.

During drive operation the surface of a disk can be damaged possibly resulting in a loss of data. The rotation of a disk around the spindle causes air to move beneath a slider. The slider can glide over the moving air at a uniform distance above the surface of the rotating disk, thus, avoiding contact between the read/write head and the surface of the disk.

Sliders are made of ceramic material that includes among other things Al₂O₃ (also known as alumina) and TiC (also known as titanium carbide). As disk drives are handled during the manufacturing process, various materials from the slider may crack or even break off resulting in particles. A particle of alumina or titanium carbide, among other things, can cause damage to the disk if the particle comes between the slider's air bearing surface and the disk.

### SUMMARY OF THE INVENTION

Embodiments of the present invention pertain to extracting particles from a slider to enable particle quantification. According to one embodiment, a slider, which is associated with a head stack assembly, is submerged into a solution. Particles are extracted from the slider without extracting particles from the entire head stack assembly.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of a disk drive for facilitating the discussion of various embodiments of the present invention.

FIG. 2 depicts a detailed side view of a system for localized particle extraction, according to one embodiment.

FIG. 3 depicts various components of a system, according to one embodiment.

FIG. 4 depicts a top down view of the various components depicted in FIG. 3 after they have been assembled, according to one embodiment.

FIG. 5 depicts a side view of the various components after they have been assembled, according to one embodiment.

FIG. 6 depicts results of analyzing particles extracted from a slider 250 using various embodiments of the present invention.

FIG. 7 depicts a flowchart describing a method for extracting particles from a slider to enable particle quantification, according to one embodiment of the present invention.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

As already stated, particles of alumina or titanium carbide may crack or break off from a slider during the manufacturing process. These particles can cause damage to the disk in the event that a particle comes between the slider and the disk. Therefore, the risk of these types of particles to a disk drive after the slider has been assembled, for example, with a head stack assembly (HSA) is evaluated.

According to one embodiment, a method of extracting particles from a slider to enable particle quantification is provided. A slider that is associated with an HSA can be submerged into a solution. Particles are extracted from the slider without extracting particles from the entire HSA, thus, enabling quantification of particles that originate from the slider's material, for example because the slider's material cracked or broke off. According to one embodiment, extracting particles from the slider without extracting particles from the entire HSA is referred to as “localized particle extraction.”

### A Disk Drive

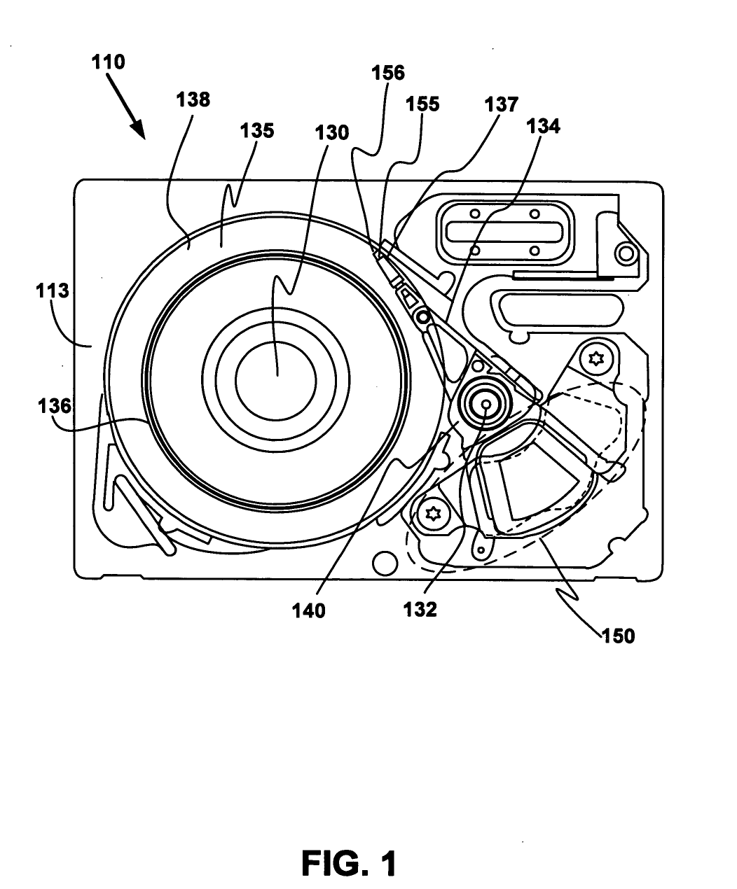

FIG. 1 depicts a plan view of a disk drive for facilitating the discussion of various embodiments of the present invention. The disk drive 110 includes a base casting 113, a motor hub assembly 130, a disk 138, actuator shaft 132, actuator arm 134, suspension assembly 137, a hub 140, voice coil motor 150, a magnetic head 156, and a slider 155.

The components are assembled into a base casting 113, which provides attachment and registration points for components and sub assemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 138's surface 135 for reading and writing data with magnetic heads 156 (one shown). The rotary voice coil motor 150 rotates actuator arms 135 about the actuator shaft 132 in order to move the suspension assemblies 150 to the desired radial position on a disk 138. The actuator shaft 132, hub 140, actuator arms 134, and voice coil motor 150 may be referred to collectively as a rotary actuator assembly.

Data is recorded onto the disk's surface 135 in a pattern of concentric rings known as data tracks 136. The disk's surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 10 only shows one head and one disk surface. Various parts and subassemblies of a disk drive 110 can have contaminates removed using various embodiments described herein.

### System for Localized Particle Extraction

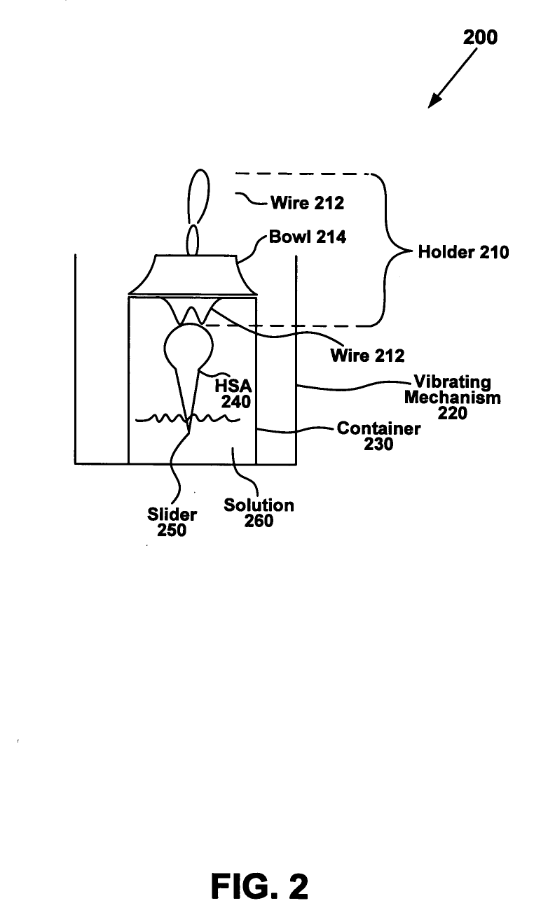

FIG. 2 depicts a detailed side view of a system 200 for localized particle extraction, according to one embodiment. As depicted in FIG. 2, the system includes a localized particle extraction container 230, a localized particle extraction holder 210 and a localized particle extraction vibrating mechanism 220. The localized particle extraction holder 210 according to one embodiment includes a bowl 214 and a wire 212.

The container 230 can contain a solution 260 for extracting particles from the slider 250. The slider 250 may be assembled into an HSA 240. The HSA 240 can be suspended from the wire 212 associated with the holder 210 so that the slider 250 is submerged in the solution 260. The particles can be extracted from the submerged portion of the slider 250 for example using sonification, as will become more evident. The extracted particles can be analyzed to determine the type of materials the particles are made of. For example, according to one embodiment, it can be determined whether the particles are made of alumina, titanium carbide, stainless steel class 300, stainless steel class 400, and so on. Particles of alumina and titanium carbide are examples of particles that resulted from a slider's material cracking or breaking off.

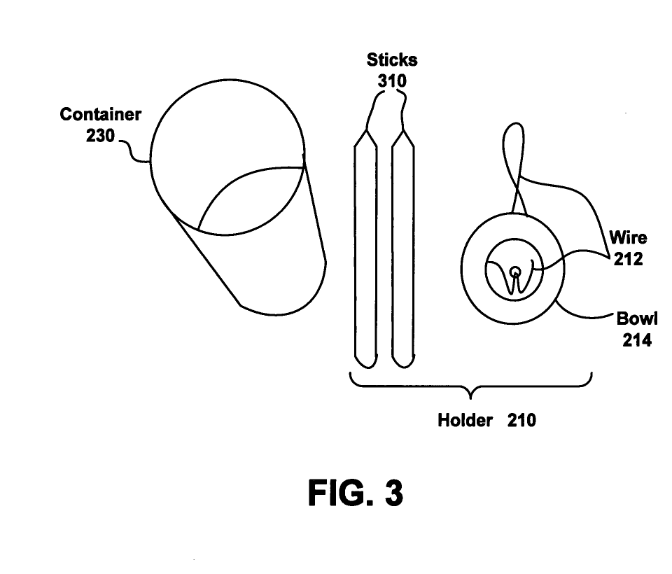

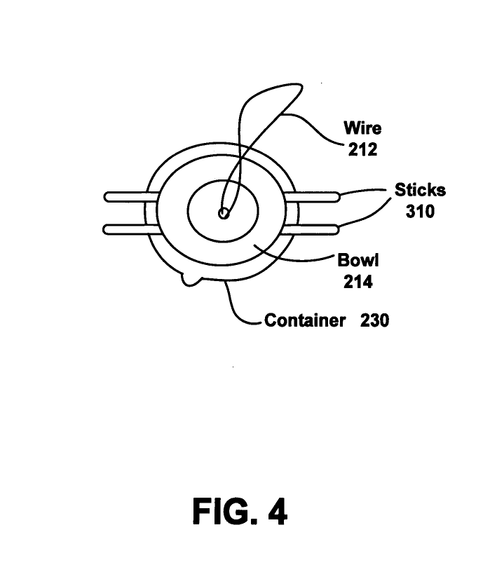

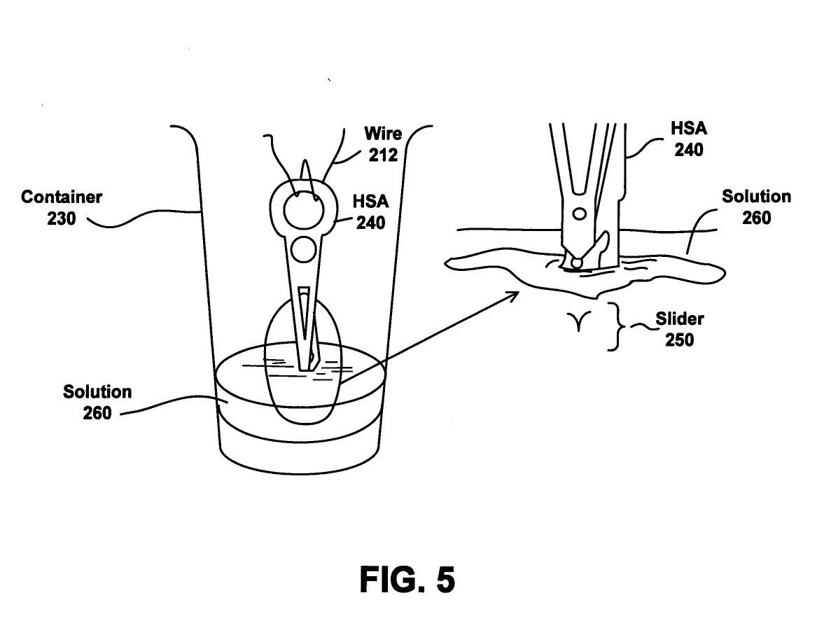

FIG. 3 depicts various components of a system 200, according to one embodiment. The components depicted in FIG. 3 include a container 230 and a holder 210. For example, the container 230 can be a clean beaker. The holder 210 could include a bowl 214 with wire 212 and one or more sticks 310. FIG. 4 depicts a top down view of the various components depicted in FIG. 3 after they have been assembled, according to one embodiment. FIG. 5 depicts a side view of the various components after they have been assembled, according to one embodiment.

Referring to FIG. 3, solution can be put into the container. Referring to FIG. 5, the HSA 240 can be hung from the holder's wires 212 at the voice coil. Referring to FIG. 4, the two sticks 310 are laid on top of the container 230. Referring to FIG. 4, the bowl 214 of the holder 210 can be placed on top of the two sticks 310 so that, referring to FIG. 5, the slider 250 is submerged in the solution 260 without submerging the entire HSA 240 in the solution 260.

The container 230 along with the slider/HSA combination and the holder 210 can be placed in a vibrating mechanism 220. According to one embodiment, the vibrating mechanism 220 is an ultrasonic tank. Sonification is performed causing particles to be extracted from the slider 250. Since the entire HSA 240 is not submerged, particles from the entire HSA 240 are not extracted.

### Solution

According to one embodiment, the solution 260 is used to remove particles from a slider 250. For example, the solution 260 can be water from the manufacturing site's treatment plant. The water is di-ionized to remove ion contaminates, according to one embodiment. The solution 260 may include a fixed amount of detergent, such as 0.004% Micro-90 detergent. The detergent, according to one embodiment, facilitates removal of the particles from the slider 250.

### Slider

According to one embodiment, the slider 250 is a pico slider. The air bearing surface (ABS) of a pico slider is approximately 1.1 millimeters (mm) to 1.2 mm. However, the slider 250 can be any type of slider that is associated with a HSA 240 of a hard disk drive.

According to one embodiment, the slider 250's center plus 3-5 mms of the HSA 240 are submerged in solution 260. For example, the slider 250 and part of the HSA 240 almost to the mount plate can be submerged. According to one embodiment, approximately 7 mm to 10 mm are submerged depending on the type of slider. In order to compare results, the same amount is submerged for all of the sliders that extraction is performed on. Sliders that extraction is performed on are also referred to as “sample sliders.”

### Localized Particle Extraction Container

According to one embodiment, the container 230 is used for containing solution 260 that a slider 250, which is associated with a HSA 240 of a hard disk drive, can be submerged in. According to one embodiment, the container 230 is a clean beaker. For example the clean beaker may be approximately 110 milliliters (ml) to 400 ml.

### Localized Particle Extraction Holder

According to one embodiment, the holder 210 is used for holding the HSA 240 so that the slider 250 is submerged in the solution 260 without submerging the entire HSA 240 in the solution 260. According to one embodiment, a holder 210 includes a bowl 214 and a wire 212. The holder 210 can also include one or more sticks 310. The bowl 214 can be a paper bowl and the wire 212 can be a nylon wire. The sticks 310 may be wooden sticks. The wire 212 can be inserted through a hole in the bowl 214 and twisted. The HSA 240 can be suspended from the holder 210 from the wires 212 at the voice coil.

Other mechanisms and materials can be used besides a paper bowl and nylon wire. For example, the bowl 214 can be made out of plastic or ceramic, among other things. Further, instead of a bowl another shaped mechanism such as a plate could be used. Instead of nylon, metal wire or a string made of some type of fabric, among other things, could be used. According to one embodiment, the term “cord” includes a wire made of any type of material or a string. According to one embodiment, the term “suspension component” includes any type of component, such as a bowl or plate, for suspending a slider 250 that is associated with an HSA 240.

According to one embodiment, the sticks 310 are not required. For example, if the bowl 214 or plate that the wire 212 is put through may be large enough to be held in place over the container 230. According to one embodiment, the suspension component includes the sticks 310. The sticks 310 may be made out of other materials besides wood. For example, the sticks 310 may be plastic or metal.

### The Localized Particle Extraction Vibrating Mechanism and Extraction

According to one embodiment, particles are extracted from the slider 250. According to one embodiment, the localized particle extraction vibrating mechanism 220 is an ultrasonic tank, such as a Branson 40 kilohertz (kHz) ultrasonic tank. According to one embodiment, approximately 200-1000 Watts of power and approximately 20-140 kHz frequency are used to extract the particles for approximately 20-120 seconds. According to one embodiment, 240 watts are used at a frequency of 40 kHz for 80 seconds.

### Filtering and Analyzing

According to one embodiment, the solution 260 that contains the particles extracted from the slider 250 is filtered. For example, a polycarbonate membrane with a pore size of approximately 0.2 um to 0.4 um can be used to filter all of the solution 260 using a filter device with a spot size of approximately 203 mm.

A SEM/EDX particle count and identification for alumina, among other things, can be performed on the filtered solution. The membrane can be transferred to a carbon tape placed in an aluminum stud and sent for auto-SEM analysis. The membrane that has been used to filter the solution is also referred to as a “filtered sample.” The filtered sample can be analyzed with a SEM LEO-1430 with EDAX Phoenix EDS Microanalysis using accelerated voltages of 20 kV under a magnification of 1000×. According to one embodiment, one or more location on each filtered sample can be analyzed. According to one embodiment, more than one location is analyzed to ensure a wide coverage of particle distribution. For example, 3 locations of the filtered sample can be analyzed. Particle count can be performed on one or more locations. For example, particle count can be performed on 2 of the 3 locations that were analyzed. Particle count and identification can also be performed on one or more of the locations. Assume for the sake of illustration that 3 locations were analyzed, that particle count was performed on 2 of the 3 locations and that particle count and identification was performed on 1 of the 3 locations. In this example, 4×3 equals 12 fields could be analyzed for each location. The area analyzed per location could equal (4×3) fields×(0.119×0.089) field size which equals 0.126 mm². The final data reported could be equal to ((average of the raw data of the 3 locations)×((3.14*1.5²)/(0.119*0.089*12))).

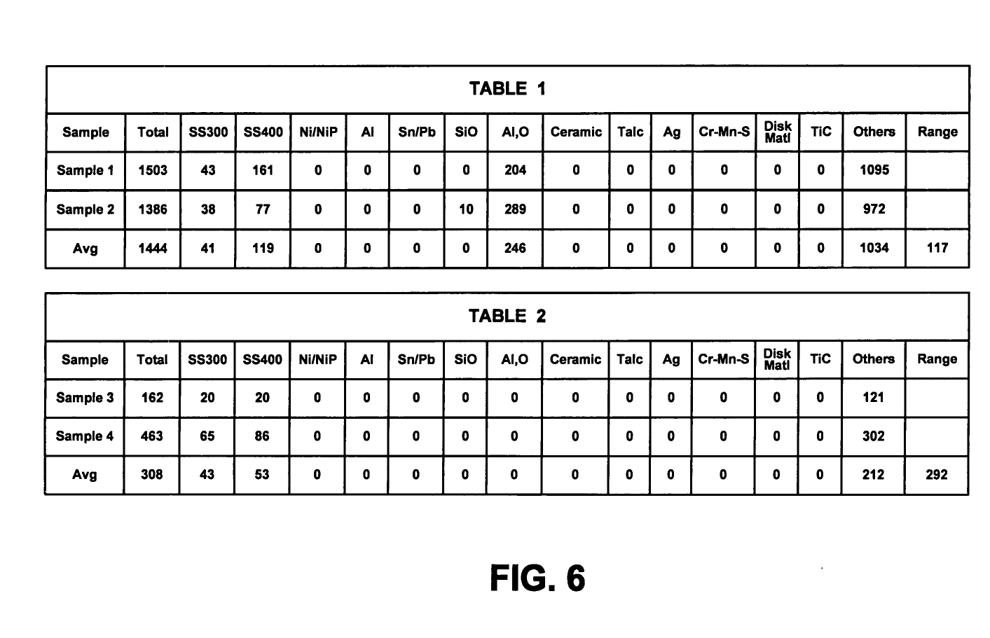

FIG. 6 depicts results of analyzing particles extracted from a slider 250 using various embodiments of the present invention. An operator for the manufacturing process of HDDs can choose to use fast release or slow release. It has been suspected that fast release can result in the sliders 250 coming into contact with each other resulting in the sliders' 250 material cracking or breaking off. However, to date there has been no methodology to confirm this theory. Testing this theory is important to the industry. Therefore, there has been a long felt need for extracting particles from a slider to enable particle quantification. Further, although there are prior art methods of performing qualitative analysis on sliders, to date there has been no method to quantify particles that originate from the slider's materials.

Still referring to FIG. 6, Table 1 depicts results of extracting particles from sliders and analyzing the extracted particles using various embodiments where the sliders were subjected to fast release. Table 2 depicts results of extracting particles from sliders and analyzing the extracted particles using various embodiments where the sliders were subjected to slow release. Two samples of sliders were analyzed for fast release and for slow release. As can be seen, the number of particles was much higher where fast release was used instead of slow release. Table 1 shows a total of 1503 particles for sample 1 and 1386 for sample 2. In contract, table 2 shows a total of 162 particles for sample 3 and 453 for sample 4. Also note that the particles are broken down by types of materials. The column for alumina sample 1 depicts 204 particles and sample 2 depicts 289 particles, whereas samples 3 and 4 depict 0 particles. Since sliders are made of alumina, among other things, the large difference in the number of alumina particles confirms that sliders can be damaged during fast release.

### Method of Extracting Particles From a Slider to Enable Particle Quantification

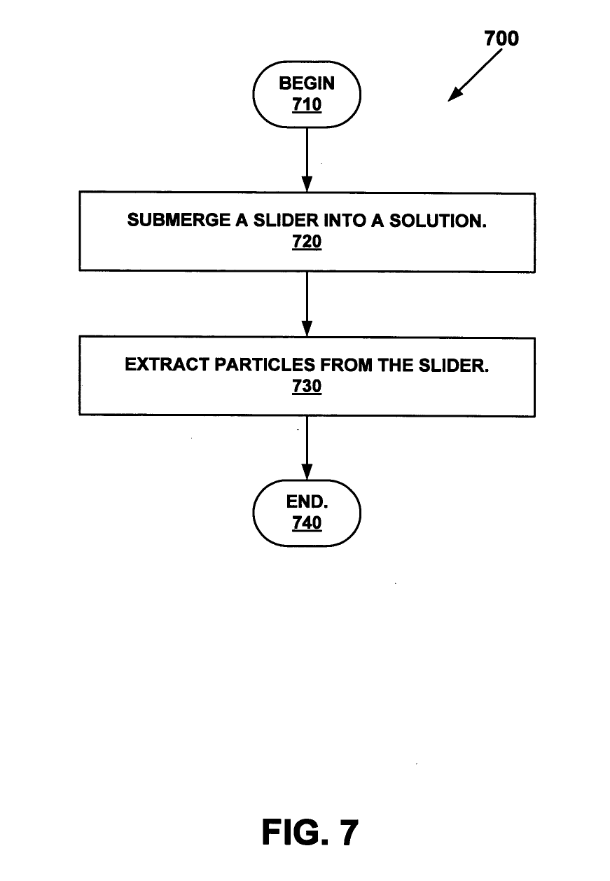

FIG. 7 depicts a flowchart 700 describing a method for extracting particles from a slider to enable particle quantification, according to one embodiment of the present invention. Although specific steps are disclosed in flowchart 700, such steps are exemplary. That is, embodiments of the present invention are well suited to performing various other steps or variations of the steps recited in flowchart 700. It is appreciated that the steps in the flowchart 700 may be performed in an order different than presented, and that not all of the steps in flowchart 700 may be performed.

At step 710, the method begins.

At step 720, a slider is submerged into a solution. For example, the slider and the head stack assembly can be assembled together. Referring to FIG. 3 depicts various components of a system 200, according to one embodiment. The components depicted in FIG. 3 include a container 230 and a holder 210. For example, the container 230 can be a clean beaker. The holder 210 could include a bowl 214 with wire 212 and two sticks 310. The sticks 310 may be wooden sticks. The bowl 214 may be a paper bowl. The wire 212 may be a nylon wire. FIG. 4 depicts a top down view of the various components depicted in FIG. 3 after they have been assembled, according to one embodiment. FIG. 5 depicts a side view of the various components after they have been assembled.

Referring to FIG. 3, solution 260 can be put into the container 230. Referring to FIG. 5, the HSA 240 can be hung from the holder 210's wires 212 at the voice coil. Referring to FIG. 4, the two sticks 310 can be laid on top of the container 230. The bowl 214 of the holder 210 can be placed on top of the two sticks 310 so that referring to FIG. 5 the slider 250 is submerged in the solution 260 without submerging the entire HSA 240 in the solution 260.

According to one embodiment, the slider 250's center plus 3-5 mms of the HSA 240 are submerged in solution 260. For example, the slider 250 and part of the HSA 240 almost to the mount plate can be submerged. According to one embodiment, approximately 7 mm to 10 mm are submerged depending on the type of slider 250. In order to compare results, the same amount is submerged for all of the sliders 250 that extraction is performed on.

At step 730, particles are extracted from the slider without extracting particles from the entire head stack assembly. For example, the container 230 along with the slider/HSA combination and the holder 210 can be placed in a vibrating mechanism 220. According to one embodiment, the vibrating mechanism 220 is an ultrasonic tank, such as a Branson 40 kilohertz (kHz) ultrasonic tank. Sonification can be performed causing particles to be extracted from the slider 250. According to one embodiment, approximately 200-1000 Watts of power and approximately 20-140 kHz frequency and used to extract the particles for approximately 20-120 seconds. According to one embodiment, 240 watts are used at a frequency of 40 kHz for 80 seconds. According to one embodiment, particles from the submerged portion are extracted. Since the entire HSA 240 is not submerged, particles from the entire HSA are not extracted.

At step 740, the method ends.

Particles that have been extracted using steps 720 and 730 can be filtered and analyzed as described, among other places, under the subheading “Filtering and Analyzing.”

What is claimed is:

1. A method of extracting particles from a slider to enable particle quantification, the method comprising:
submerging the slider into a solution, wherein the slider is associated with a head stack assembly; and
extracting the particles from the slider without extracting particles from the entire head stack assembly.

2. The method as recited in claim 1, further comprising:
putting the solution in a container and submerging the slider in the solution that is in the container.

3. The method as recited in claim 1, further comprises:
filtering the extracted particles from the solution

4. The method as recited in claim 3, further comprises:
analyzing the extracted particles.

5. The method as recited in claim 4, further comprises:
determine the types of materials that the extracted particles are made of.

6. The method as recited in claim 1, wherein the extracting of the particles from the slider further comprises:
using sonification as a part of the extracting of the particles from the slider.

7. A system of localized particle extraction, the system comprising:
a localized particle extraction container for containing solution that a slider can be submerged in, wherein the slider is associated with a head stack assembly;
a localized particle extraction holder for holding the head stack assembly so that the slider is submerged in the solution without submerging the entire head stack assembly in the solution; and
a localized particle extraction vibrating mechanism for vibrating the holder while the slider is submerged in the solution so that particles from the slider are extracted without extracting particles from the entire head stack assembly.

8. The system of claim 7, wherein the localized particle extraction container is a beaker.

9. The system of claim 7, wherein the localized particle extraction holder includes a cord and a suspension component.

10. The system of claim 7, wherein the localized particle extraction vibrating mechanism is an ultrasonic tank.

11. The system of claim 10, wherein the ultrasonic tank is a Branson 40 kilohertz ultrasonic tank.

12. The system of claim 7, wherein approximately 200-1000 Watts of power are used for vibrating the holder.

13. The system of claim 12, wherein approximately 240 Watts of power are used for vibrating the holder.

14. The system of claim 7, wherein approximately 20 to 140 kilohertz frequency is used for vibrating the holder.

15. The system of claim 14, wherein approximately 40 kilohertz frequency is used for vibrating the holder.

16. The system of claim 7, wherein the holder is vibrated for approximately 20 to 120 seconds.

17. The system of claim 16, wherein the holder is vibrated for approximately 80 seconds.

18. The system of claim 7, wherein the localized particle extraction holder includes one or more sticks.

19. A system of localized particle extraction, the system comprising:
localized particle extraction containing means for containing solution that a slider can be submerged in, wherein the slider is associated with a head stack assembly;
localized particle extraction holding means for holding the head stack assembly so that the slider is submerged in the solution without submerging the entire head stack assembly in the solution; and
localized particle extraction vibrating means for vibrating the holder while the slider is submerged in the solution so that particles from the slider are extracted without extracting particles from the entire head stack assembly.

20. The system of claim 19, further comprising:
a filtering and analyzing means for determining the amount of particles that originate from the slider's material.
